(19) United States
(12) Patent Application Publication
(10) Pub. No.: US 2017/0171527 A1
(43) Pub. Date: Jun. 15, 2017

(54) Method and System for Generating Three-Dimensional Image

(71) Applicant: Theia Limited, Zhubei City (TW)

(72) Inventor: Yu-Hsuan Lin, Zhubei City (TW)

(21) Appl. No.: 14/964,711

(22) Filed: Dec. 10, 2015

(51) Int. Cl. H04N 13/00; H04N 13/04; H04N 13/02

(52) U.S. Cl. CPC H04N 13/0037; H04N 13/0203; H04N 13/0257; H04N 13/0422; H04N 13/0271

(57) ABSTRACT

A method and system for generating three-dimensional image are provided. The system includes a image device, a controller coupled to the image device, and a display coupled to the controller. The image device is used for capturing at least a image and outputting a first image information. The controller is suited for processing the first image information or converting the first image information to a second image information. The display can receive the first image information processed by the controller or the second image information converted by the controller, and then displaying a three-dimensional image. Wherein, the image information received by the display includes a depth information and be with at least one image format of RGB, YUV, and YCbCr.

### BACKGROUND OF THE INVENTION

Field of Invention

The present invention relates to a method and system for generating image, especially relates to a method and system for generating three-dimensional image.

Description of Related Art

Support and demand for image systems that support three-dimensional (3-D) image has increased rapidly in recent years. Both literally and physically, 3-D image provides a whole new way to watch image, in home and in theaters. However, 3-D image systems are still in their infancy in many ways and there is much room for improvement in terms of both cost and performance.

Further limitations and disadvantages of conventional and traditional approaches will become apparent to one of skill in the art, through comparison of such systems with some aspects of the present invention as set forth in the remainder of the present application with reference to the drawings.

### SUMMARY OF THE INVENTION

One aspect of the invention is to provide a method and system for generating three-dimensional image. The method and system for generating three-dimensional image meets the demand for reducing cost.

To achieve the foregoing and other aspects, a system for generating three-dimensional image is provided. The system includes a image device, a controller coupled to the image device, and a display coupled to the controller. The image device is used for capturing at least a image and outputting a first image information. The controller is suited for processing the first image information or converting the first image information to a second image information. The display can receive the first image information processed by the controller or the second image information converted by the controller, and then displaying a three-dimensional image. Wherein, the image information received by the display includes a depth information and be with at least one image format of RGB, YUV, and YCbCr.

In one embodiment of the present invention, the image device is a RGB-D camera, and the first image information outputted by the RGB-D camera includes the depth information and be with the RGB format.

In one embodiment of the present invention, the first image information with RGB format be converted to the second image information with YUV or YCbCr format.

In one embodiment of the present invention, the image device is a three-dimensional camera, and the first image information outputted by the three-dimensional camera includes a left eye image information and a right eye image information.

In one embodiment of the present invention, the left eye image information and the right eye image information are converted to the second image information which includes the depth information and be with RGB, YUV, or YCbCr format by the controller.

In one embodiment of the present invention, the display is a RGB-D display.

In one embodiment of the present invention, the RGB-D camera includes a color computing module for generating RGB format.

In one embodiment of the present invention, the RGB-D camera further includes a depth computing module for deriving the depth information for a plurality of arbitrary points in the image in real time.

In one embodiment of the present invention, the RGB-D camera further includes an infrared sensing module for measuring the depth information.

In one embodiment of the present invention, the image is a photo mode or a video mode.

In addition, a method for generating three-dimensional image is provided. The method includes steps as following:

providing a image device to capture at least a image and output a first image information;

providing a controller coupled to the image device to process the first image information or convert the first image information to a second image information; and

providing a display coupled to the controller to received the first image information processed by the controller or the second image information converted by the controller, and then displaying a three-dimensional image;

wherein the image information received by the display including a depth information and being with at least one image format of RGB, YUV, and YCbCr.

In one embodiment of the present invention, the image device is a RGB-D camera, and the first image information outputted by the RGB-D camera includes the depth information and being with the RGB format.

In one embodiment of the present invention, the first image information with RGB format is converted to the second image information with YUV or YCbCr format.

In one embodiment of the present invention, the image device is a three-dimensional camera, and the first image information outputted by the three-dimensional camera includes a left eye image information and a right eye image information.

In one embodiment of the present invention, the left eye image information and the right eye image information are converted to the second image information which includes the depth information and be with RGB, YUV, or YCbCr format by the controller.

In one embodiment of the present invention, the display is a RGB-D display.

In one embodiment of the present invention, the RGB-D camera includes a color computing module for generating RGB format.

In one embodiment of the present invention, the RGB-D camera further includes a depth computing module for deriving the depth information for a plurality of arbitrary points in the image in real time.

In one embodiment of the present invention, the RGB-D camera further includes an infrared sensing module for measuring the depth information.

In one embodiment of the present invention, the image is a photo mode or a video mode.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a system for generating three-dimensional image according to a first embodiment of the present invention.

FIG. 2 is a schematic view illustrating a system for generating three-dimensional image according to a second embodiment of the present invention.

FIG. 3 is a schematic view illustrating a system for generating three-dimensional image according to a third embodiment of the present invention.

FIG. 4 is a flowchart illustrating a method for generating three-dimensional image according to one embodiment of the present invention.

### DESCRIPTION OF EMBODIMENTS

Other features and advantages of the invention will be further understood from the further technological features disclosed by the embodiments of the invention wherein there are shown and described embodiments of this invention, simply by way of illustration of best modes to carry out the invention.

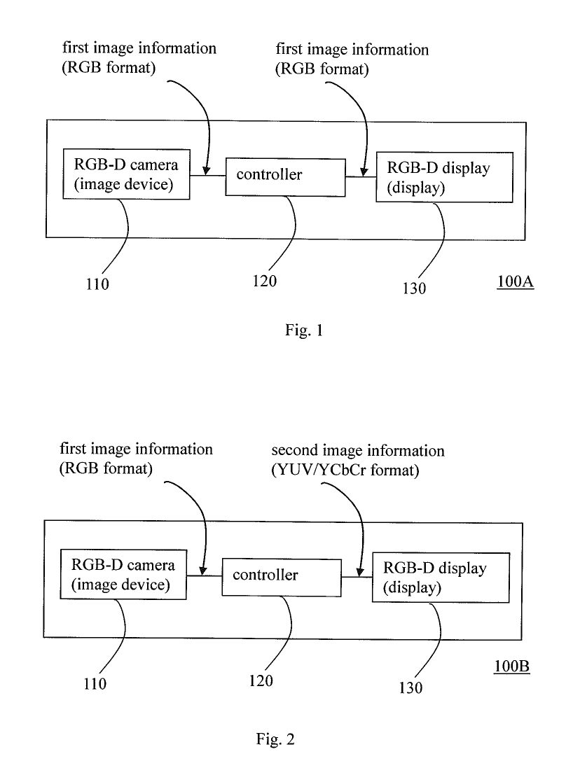

FIG. 1 is a schematic view illustrating a system for generating three-dimensional image according to a first embodiment of the present invention. Please refer to FIG. 1, the system 100A of the first embodiment includes an image device 110, a controller 120 coupled to the image device 110, and a display 130 coupled to the controller 120. The image device 110 is used for capturing at least a image and outputting a first image information, wherein the image is a photo mode or a video mode. In the first embodiment of the present invention, the image device 110 is a RGB-D camera, and the first image information outputted by the RGB-D camera includes the depth information and being with the RGB format. In addition, the controller 120 is suited for processing the first image information and then outputs to the display 130.

Worth mention, due to the first image information including the depth information and being with the RGB format, the display 130 can display a three-dimensional image after receiving the first image information processed by the controller. In the embodiment, the display 130 is a RGB-D display, for example.

In a preferred embodiment, the RGB-D camera can includes a color computing module for generating RGB format, a depth computing module for deriving the depth information, and an infrared sensing module for measuring the depth information. The depth computing module can make derivation for a plurality of arbitrary points in the image in real time to constitute a depth map. The image captured by the RGB-D camera can be used to create the first image information which comprises a red- green- blue- and depth (RGB-D) image. Further, the image captured by the RGB-D camera can be processed by the color computing module, the depth computing module, and the infrared sensing module to obtain a plurality of relative image parameters which constitute the first image information.

In the preferred embodiment, the infrared sensing module can includes an infrared transmitter and infrared COMS sensor. The RGB-D camera can acquire RGB image and depth image data. The RGB-D camera uses an optical encoder (Light Coding) technology, in which the infrared transmitter and infrared COMS sensor uses to sense the target image. Thus, the relative image parameters (like the depth map) can be captured to obtain real-time measurement of the three-dimensional information.

Furthermore, in another preferred embodiment, the color computing module, the depth computing module, and the infrared sensing module also can be built in the controller 120, and the present invention does not have any limitation.

FIG. 2 is a schematic view illustrating a system for generating three-dimensional image according to a second embodiment of the present invention. Please refer to FIG. 2, the system 100B of the second embodiment is similar to the system 100A of the first embodiment. The system 100B of the second embodiment also includes the image device 110, the controller 120 coupled to the image device 110, and the display 130 coupled to the controller 120. In addition, the image device 110 also is a RGB-D camera, and the first image information outputted by the RGB-D camera also includes the depth information and being with the RGB format.

From above, the difference between the first embodiment and the second embodiment is that: in the second embodiment of the present invention, the first image information outputted by the RGB-D camera will be converted to a second image information by the controller 120. In detail, the first image information with RGB format will be converted to the second image information with YUV or YCbCr format, wherein the second image information with YUV or YCbCr format includes the depth information similarly. Then, the display 130 can display a three-dimensional image after receiving the second image information with YUV or YCbCr format converted by the controller 120.

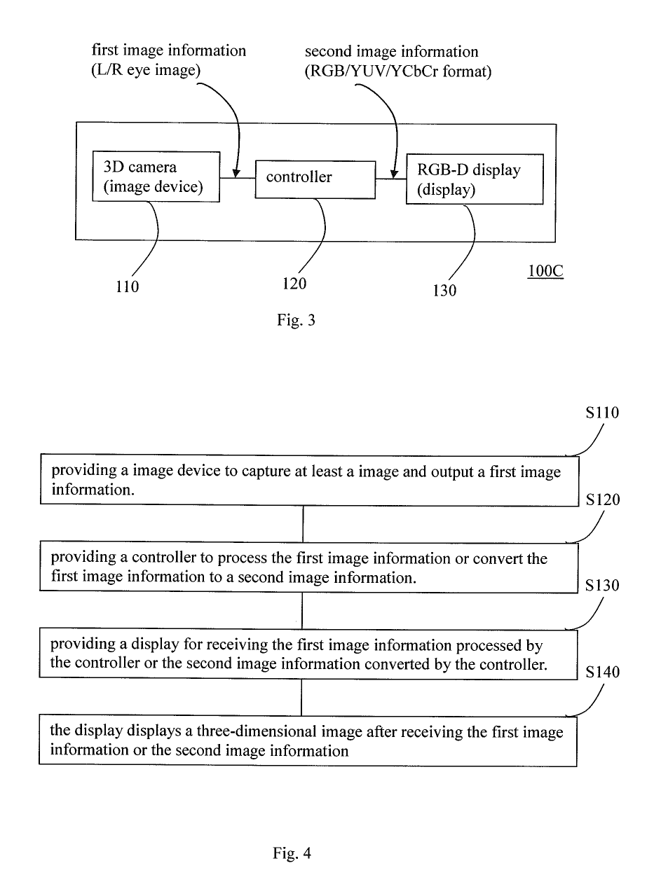

FIG. 3 is a schematic view illustrating a system for generating three-dimensional image according to a third embodiment of the present invention. Please refer to FIG. 3, in the system 100C of the third embodiment, the image device 110 is a three-dimensional camera, and the first image information outputted by the three-dimensional camera includes a left eye image information and a right eye image information. In the third embodiment of the present invention, the left eye image information and the right eye image information can be converted to the second image information by the controller 120.

Worth mention, the second image information converted by the controller 120 includes the depth information and being with RGB, YUV, or YCbCr format. Thus, the display 130 can display a three-dimensional image after receiving the second image information with RGB, YUV, or YCbCr format converted by the controller 120.

FIG. 4 is a flowchart illustrating a method for generating three-dimensional image according to one embodiment of the present invention. Please refer to FIG. 4, the method for generating three-dimensional image includes the following steps:

First, as step S110, providing an image device to capture at least an image and output a first image information;

Next, as step S120, providing a controller to process the first image information or convert the first image information to a second image information;

Then, as step S130, providing a display for receiving the first image information processed by the controller or the second image information converted by the controller; and

Thereafter, as step S140, the display displays a three-dimensional image after receiving the first image information or the second image information;

Worth mention, the image information received by the display includes a depth information and be with at least one image format of RGB, YUV, and YCbCr. The foregoing steps can applied in the first, second, third embodiment of the present invention as shown in FIG. 1-3.

Besides, in a preferred embodiment, the system for generating three-dimensional image just can include the controller and the display without the image device. This is, the image device can be provided selectively, which is not limited in the invention.

From above, in the present invention, the image information transmitted to the display just includes the depth information with RGB, YUV or YCbCr format, which can be shown as RGB-D, YUV-D or YCbCr-D. The data transmitting amount of RGB-D, YUV-D or YCbCr-D is less than the data transmitting amount of the L/R eye image information (RGB and RGB) transmitted to the display directly. Therefore, the system of the present invention requires an smaller data bandwidth for transmitting information to the display. Further, the method and system for generating three-dimensional image meets the demand for reducing cost.

Although the description above contains many specifics, these are merely provided to illustrate the invention and should not be construed as limitations of the invention's scope. Thus it will be apparent to those skilled, in the art that various modifications and variations can be made in the system and processes of the present invention without departing from the spirit or scope of the invention.

What is claimed is:

1. A system for generating three-dimensional image, comprising:
a controller, suited for processing a first image information or converting the first image information to a second image information; and
a display, coupled to the controller, and received the first image information processed by the controller or the second image information converted by the controller, and then displaying a three-dimensional image;
wherein the image information received by the display including a depth information and being with at least one image format of RGB, YUV, and YCbCr.

2. The system for generating three-dimensional image of claim 1, further comprising:
a image device, capturing at least a image and outputting the first image information, wherein the image device is coupled to the controller.

3. The system for generating three-dimensional image of claim 2, wherein the image device is a RGB-D camera, and the first image information outputted by the RGB-D camera including the depth information and being with the RGB format.

4. The system for generating three-dimensional image of claim 3, wherein the first image information with RGB format being converted to the second image information with YUV or YCbCr format.

5. The system for generating three-dimensional image of claim 2, wherein the image device is a three-dimensional camera, and the first image information outputted by the three-dimensional camera including a left eye image information and a right eye image information.

6. The system for generating three-dimensional image of claim 5, wherein the left eye image information and the right eye image information being converted to the second image information which including the depth information and being with RGB, YUV, or YCbCr format by the controller.

7. The system for generating three-dimensional image of claim 1, wherein the display is a RGB-D display.

8. The system for generating three-dimensional image of claim 3, wherein the RGB-D camera including a color computing module for generating RGB format.

9. The system for generating three-dimensional image of claim 8, wherein the RGB-D camera further including a depth computing module for deriving the depth information for a plurality of arbitrary points in the image in real time.

10. The system for generating three-dimensional image of claim 8, wherein the RGB-D camera further including an infrared sensing module for measuring the depth information.

11. The system for generating three-dimensional image of claim 2, wherein the image is a photo mode or a video mode.

12. A method for generating three-dimensional image, comprising:
providing a controller to process a first image information or convert the first image information to a second image information; and
providing a display coupled to the controller to received the first image information processed by the controller or the second image information converted by the controller, and then displaying a three-dimensional image;
wherein the image information received by the display including a depth information and being with at least one image format of RGB, YUV, and YCbCr.

13. The method for generating three-dimensional image of claim 11, further comprising:
providing a image device to capture at least a image and output the first image information, wherein the image device is coupled to the controller.

14. The method for generating three-dimensional image of claim 13, wherein the image device is a RGB-D camera, and the first image information outputted by the RGB-D camera including the depth information and being with the RGB format.

15. The method for generating three-dimensional image of claim 14, wherein the first image information with RGB format being converted to the second image information with YUV or YCbCr format.

16. The method for generating three-dimensional image of claim 13, wherein the image device is a three-dimensional camera, and the first image information outputted by the three-dimensional camera including a left eye image information and a right eye image information.

17. The method for generating three-dimensional image of claim 16, wherein the left eye image information and the right eye image information being converted to the second image information which including the depth information and being with RGB, YUV, or YCbCr format by the controller.

18. The method for generating three-dimensional image of claim 12, wherein the display is a RGB-D display.

19. The method for generating three-dimensional image of claim 14, wherein the RGB-D camera including a color computing module for generating RGB format.

20. The method for generating three-dimensional image of claim 19, wherein the RGB-D camera further including a depth computing module for deriving the depth information for a plurality of arbitrary points in the image in real time.

21. The method for generating three-dimensional image of claim 20, wherein the RGB-D camera further including an infrared sensing module for measuring the depth information.

22. The method for generating three-dimensional image of claim 13, wherein the image is a photo mode or a video mode.
